(19) United States
(12) Patent Application Publication
(10) Pub. No.: US 2019/0200601 A1
(43) Pub. Date: Jul. 4, 2019

(54) Fly Shooing Device for Animals

(71) Applicant: Yasmin Assemi, San Diego, CA (US)

(72) Inventor: Yasmin Assemi, San Diego, CA (US)

(21) Appl. No.: 15/884,927

(22) Filed: Jan. 31, 2018

Related U.S. Application Data
(60) Provisional application No. 62/613,149, filed on Jan. 3, 2018.

(51) Int. Cl. A01M 29/12; A01K 13/00

(52) U.S. Cl. CPC A01M 29/12; A01K 13/00

(57) ABSTRACT

A fly shooing device is configured for removable engagement with the hair or mane of an animal. The device includes a plurality of cords extending from a connector which removably attaches to the animal. The connector includes an elastic band which is formed of material which will break and release the device from the animal once a predetermined force is communicated to the elastic band. Elastic O-rings and a liquid absorbing bead which emits scented vapors may also be engaged to the elastic band.

This application claims priority to U.S. Provisional Patent Application Ser. No. 62/613,149, filed on Jan. 3, 2018, which is incorporated herein in its entirety by this reference thereto.

### BACKGROUND OF THE INVENTION

### 1. Field of the Invention

The present invention relates generally to the removal of flies from the face of domesticated animals such as horses. More particularly, it relates to an elongated shooing device configured for engagement with the forelock, mane, or tail of a domesticated animal such as a horse, which once so removably engaged is employable by movement of the animal, to shoo flies and insects away from the area of the device.

### 2. Prior Art

Face flies and other insects are incessant in their intent to land upon the face and eyes of domesticated animals such as horses. Such flies are troublesome and constantly annoy such animals and carry disease. Indeed, it is not uncommon for the eyes of horses, and the like, to become infected as the result of irritation from flies. Further, flies and other insects also bite domesticated animals and such can be painful, especially on the sensitive areas of the face of the animal.

Many devices have been disclosed and used in prior art in the efforts to eliminate the problem of insects and flies harassing domesticated animals such as horses. The majority of such devices all include belts and belt systems to engage screens and insect deterring fabrics to cover the face of the animal. However, such devices are very uncomfortable for the animal when worn long term, and being a constant source of irritation, they cause the animal to continually try to disengage the halter and belts holding the fly shield in front of the eyes and face of the animal.

Horses are especially noteworthy for the ability and inclination to dismount or disengage shields, and the like, which are engaged to their heads using belts and halters, which generally engage around the ears and head. With such insect preventive devices, horses will themselves catch the belts or halters on anything in the proximity of a corral, to pull and remove the device. Additionally, it is well known that other horses within the same, or a proximate, corral to a horse having gear engaged to their head, will frequently pull such from the head of the animal on which it is engaged and thereby dismount it.

Still further, in addition to requiring uncomfortable halters and belts for engagement which incite the animal to try and disengage such devices, previously disclosed devices for blocking access to the face of horses and the like by insects such as flies and mosquitos, are static. That is to say, their insect dissuading ability is not enhanced by natural movements of the horse or animal in dealing with such insects.

The fly and insect shooing device herein, is configured for removable engagement with the forelock or mane of a horse or other animal. The device is formed of very lightweight and flexible cords which are easily engaged with the forelock of an animal such as a horse, positioning the flexible cords in a position where they will not impede the vision of the horse or animal and are not noticeable by the animal due to the light weight construction. So positioned, out of the view of the horse or other animal, the cords act as whips which move to shoo flies from the face of the animal during the natural shaking of the head of the horse or other animal. Additional insect deterrence is provided by the positioning of a scent exuding bead or the like, which can be impregnated with oils or liquid scents such as peppermint, citrus, or lavender and the like, to further dissuade flies and mosquitos and the like from approaching and landing on the face or eyes of the animal.

It should be noted, the foregoing examples of related art for fly and insect repelling devices and the like and limitations related therewith are intended to be illustrative and not exclusive, and they do not imply any limitations on the topiary system described and claimed herein. Various limitations of the related art are already known or will become apparent to those skilled in the art upon a reading and understanding of the specification below and the accompanying drawings.

An object of the present invention is the provision of a removably engageable fly and insect dissuading device which engages on the forelock or mane of a horse or other domestic animal and, when not in use, remains out of the field of view of the animal.

An additional object of the invention herein is the provision of such an insect dissuading device, which is light weight, not easily noticed by the animal, but which acts as a whip during the natural head shaking of the animal in actions to scare and dissuade insects from landing on their face and eyes.

A further object of the invention is the provision of such an insect dissuading device, which is engaged with a lightweight and easily broken mounting material to dismount the device should portions of it become caught on something to prevent animal injury.

Further objectives of the insect shooing and dissuading system herein will be brought out in the following parts of the specification wherein the summary and detailed description of the invention are for the purpose of fully disclosing the invention without placing limitations thereon.

### SUMMARY OF THE INVENTION

The present invention provides a device and method solving shortcomings and dilemma in the art shooing and preventing insects from landing on the face and in the eyes of domesticated animals such as horses. It does so with a lightweight device formed of a plurality of flexible cords and a connector for removable engagement of one end of the plurality of cords to the forelock or mane of the horse. Currently a total weight of the device including the connector, the absorbent bead, and the plurality of cords having a total weight between 0.3 ounces and 1 ounce have been found in experimentation to be best ignored by the horse when engaged. This is an important aspect because horses are notorious for acting to remove items engaged to their body by any means necessary.

The plurality of cords extending from the mount and mount end to a distal end, are best when formed in lengths between 12-19 inches. While originally longer lengths were thought to move better in a whipping action during head movements of the animal, it was found that the longer lengths tended to cause the ends thereof to hit the horse in the face during running which could spook or otherwise irritate the horse. Lengths between 12-19 inches, however, worked well to shoo and dissuade flies during natural head movements of the animal and did not strike the animal in the face during running. Further, the cords tended to hang naturally in-between the eyes of the horse and out of eyesight when engaged to the forelock or the mane in between the ears. This is most important to keep the horse or other animal from trying to dismount the device which occurs when the eyesight is blocked.

To engage the device with the forelock or mane of a horse or other domesticated animal, at a mounting end is located a removably engageable connector. The connector is adapted to comfortably engage the mounting end to the forelock or mane in a manner which will release the connector from the cords or the connector from the forelock easily, should the cords be caught upon something or otherwise pulled upon. Such helps prevent injury to the animal.

A preferred connector includes an elastic band, which engages at one end with a wrap around of the cords and forms an opening at the other end, to engage with the mane or forelock much like a rubber band engages the pony tail of long hair on a human. Currently, the elastic band of choice is between 30-60 mm around a circumference and has a width between 3-5 mm.

The elastic band, or other severable connection of the cords to the connector, is formed of a material in a width and thickness such that it will break when subjected to a force upon it of between substantially 10-30 pounds. This is most preferred as it will cause the elastic band to break and the chords to disengage from the connector, should the cords get stuck upon something in the corral or pasture, or should they be pulled upon such as by another animal or horse. This disengagement is preferred to avoid injury to the horse or animal and the loss of the hair of the forelock or mane during such a pulling or other force on the cords. The engagement of the cords to the connector can also be by another breakable connection such as with a plastic or polymeric connection of both cords to the connector which will break when a force exceeding a maximum is exerted on the cords.

While the connector on the engagement end of the cords may be as simple as the elastic band which will break and release when pulled upon, additionally provided may be the inclusion of an absorbent bead such as a bead formed of lava which can absorb oils or liquids. The inclusion of the bead is preferred to enhance the fly and insect dissuasion capability of the device. When infused with scent concentrate or essential oils the absorbent bead will continuously act as a diffuser and thereby emit scents on an ongoing basis.

An absorbent polymer bead or other ceramic bead may also be employed if they will absorb the liquids and/or essential oils employed herein to dissuade flies, mosquitos and the like. Currently, the provision of such an absorbent bead on the engagement end of the device infused with one or a combination of scented liquids from a group including lavender, peppermint, spearmint, orange oil, and citrus oils.

In a particularly preferred mode of the device herein, which has been found to form an especially stable positioning of the absorbent bead adjacent the cords, and to extend the elastic band from the bead in a fashion that is easily engaged to the forelock or mane, the provision of a pair of O rings on opposing sides of the absorbent bead is provided with the formed connector. A passage running through the O rings aligns with the passage running through the absorbent bead. A diameter of the passage in the O-ring, is currently ½ the diameter of the planar elastic band, and forms a compressive engagement of the elastic band once threaded therethrough.

Thus, the elastic band, once engaged around the cords at the engagement end, follows a formed pathway through a first O-ring abutting one side of the bead, through the passage in the bead, and through the pathway in the second O-ring abutting the other side of the bead. The compressive engagement of both O-rings on the elastic band, maintains them stationary and thereby maintains the bead in a stationary position on the mount.

To adapt the connector formed at the engagement end of the device for easy but releasable engagement to the forelock or mane of a horse or animal, the formed connector additionally includes a releasable hair engaging fastener such as a hair clip or a mini cord lock. A hair clip, so employed as a fastener, would provide an easily engageable serpentine pathway for positioning of the forelock or mane therein by a user. The mini cord lock employed as the fastener would function in a similar fashion by providing an aperture for positioning of the hair of the forelock or mane therein, which would be held by a spring loaded piston contacting it. The mini cord lock or the hair clip would be operatively engaged to the elastic band to provide a breakable release upon the imparting of excess force to the cords.

With respect to the above description, before explaining at least one preferred embodiment of the herein disclosed fly shooing and insect dissuading device in detail, it is to be understood that the invention is not limited in its application to the details of construction and to the arrangement in the following description or illustrated in the drawings. The forelock engageable horse actuated insect shooing device herein described is capable of other embodiments and of being practiced and carried out in various ways which will become obvious to those skilled in the art upon reading this disclosure. Also, it is to be understood that the phraseology and terminology employed herein are for the purpose of description and should not be regarded as limiting.

As such, those skilled in the art will appreciate that the conception upon which this disclosure is based, may readily be utilized as a basis for the designing of other horse actuated fly shooing devices and for carrying out the several purposes of the present disclosed system. It is important, therefore, that the claims herein be regarded as including such equivalent construction and methodology, insofar as they do not depart from the spirit and scope of the present invention.

### BRIEF DESCRIPTION OF DRAWING FIGURES

The accompanying drawings, which are incorporated herein and form a part of the specification, illustrate some, but not the only or exclusive examples of embodiments and/or features of the invention. It is intended that the embodiments and figures disclosed herein are to be considered illustrative rather than limiting.

In the drawings:

FIG. 1 shows a fully assembled fly shooing and insect dissuading device which is adapted with a connector at a first or engagement end for a force-releasable engagement with the forelock or mane of a horse or animal wherein the connector has all of the components herein described included.

FIG. 2 is an enlarged view of the connector at the engagement end of the device of FIG. 1, showing a mode having an elastic band in an biased encircled engagement around the cords and where the band communicates through compressive passages of first and second O-rings and through a channel within a bead located in a sandwiched positioning between the two O-rings.

FIG. 3 the device similar to FIGS. 1-2 but without the elastic O-rings, but employing a channel in a bead smaller than the width of the band to form a biased engagement with the elastic band and additionally having a clip at a first end, configured with a serpentine path for engagement of the forelock or mane of the animal therethrough.

FIG. 4 shows the device in similar configuration to that of FIGS. 1-3 but having a cord lock engaged with the first end of the elastic band where the cord lock has a passage for compressive engagement hair of the forelock or main therethrough.

FIG. 4A depicts the device in similar configuration to that of FIGS. 1-4 but without an absorbent bead and engaged using the elastic band which is held in compressed engagement encircling the cords by compression from an elastic ring or O-ring in between a first end of the elastic band and a second end thereof.

FIG. 5 shows the device in any of FIGS. 1-4 in an as-used positioning with the plurality of cords hanging from the connector and out of the view of a horse with the engagement end in a force-releasable engagement with the forelock of a horse using solely the elastic band or the elastic band engaged with a clip having a serpentine path or a cord lock.

### DETAILED DESCRIPTION OF THE PREFERRED EMBODIMENTS OF THE INVENTION

In this description, any directional prepositions if employed, such as up, upwardly, down, downwardly, front, back, first, second, top, upper, bottom, lower, left, right and other such terms referring to the device or depictions as such may be oriented, are describing it such as it appears in the drawings and are used for convenience only. Such terms of direction and location are not intended to be limiting or to imply that the device herein has to be used or positioned in any particular orientation.

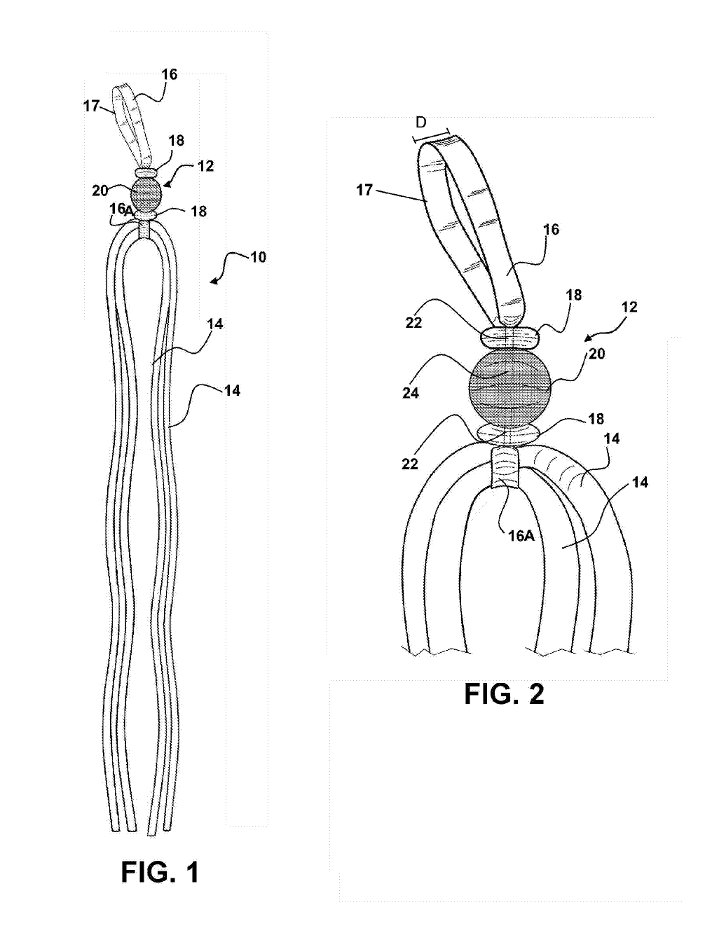

Now referring to drawings in FIGS. 1-5, wherein similar components are identified by like reference numerals, there is seen in FIGS. 1-2, the horse actuated and force-releasable fly shooing device 10 herein, fully assembled in one preferred mode. In this mode, as with others herein, a connector 12 is shown in an engagement position on one or a plurality of cords 14. As shown in FIGS. 1-5, the connector 12 in all modes preferably includes a breakable engagement of the connector 12 to the cords 14, or the connector 12 to the animal which will release at a predetermined force in a breakable engagement.

This breakable engagement in all modes of the device 10, is currently shown as a tearing or breaking of the elastic band 16 either at a first portion 17 which engages with the animal, or, at a second elastic band portion 16A, of the elastic band 16, opposite the first portion 17, which is compressively engaged around the plurality of cords 14.

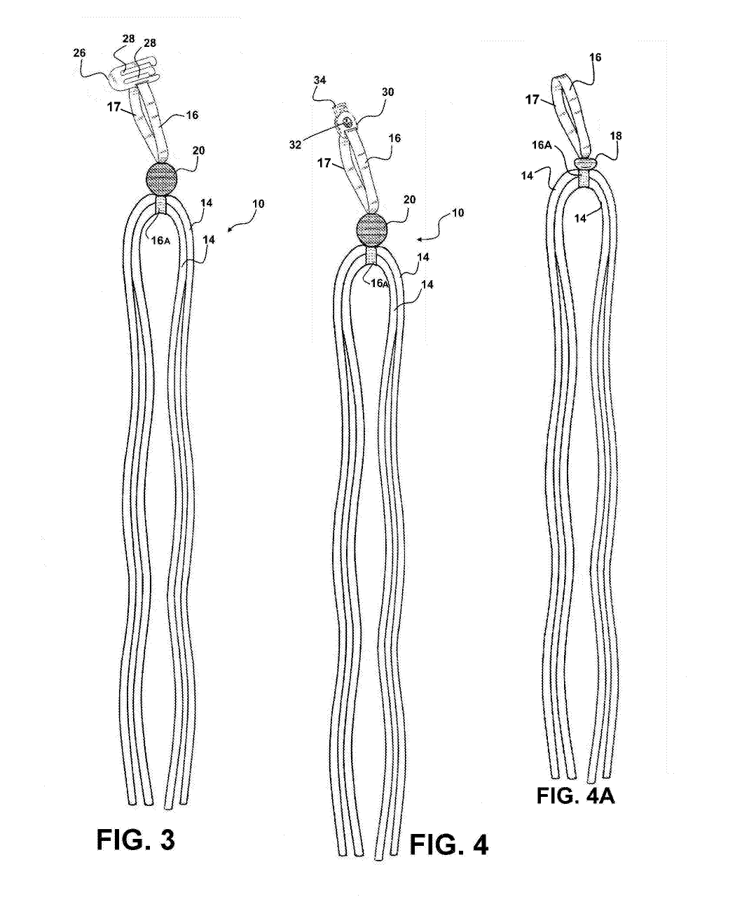

The breakable connection can be formed not only of the elastic band 16 at the first portion 17 or at the second elastic band portion 16A, but could be another polymeric or plastic compressive connector positioned to encircle and maintain the cords 14 engaged to the connector 12 at the position of the second portion 16A, and configured to break at a maximum between substantially 10-30 pounds of force. However, currently, the elastic band 16 breakable connection at the first portion 17 or second portion 16A as engaged and forming the connector 12, has in experimentation performed well with a calculated release. Further, it may be easily engaged directly by the first portion 17 of the elastic band 16 directly, or with an interfacing fastener such as 26 FIG. 3 or 30 in FIG. 4, to the mane or forelock of the animal such as a horse, in a manner in which experimentation has shown to be we tolerated by horses, who do not tolerate bows and attachments to the head well, and is as such especially preferred.

As noted above, the elastic band 16 is preferably formed of rubber or a polymeric material or the like, in a width or diameter D, and a thickness, which is configured to break when a force of between substantially 10-30 pounds, is communicated from the engaged cords 14 to the second cord portion 16A of the elastic band 16 which is in a compressive encircling engagement around of the cords 14 and holding the cords 14 to the second end of the connector 12. By substantially, is meant plus or minus 10 pounds.

While a lesser weight maximum resistance to breaking was originally thought preferable such as eight pounds, such caused the band 16 to break too easily when the animal shook their head or rubbed it against a structure. Unexpectedly, it was found that the animal learned they could dismount the device 10 in this fashion and would try to do so. Consequently, the higher maximum breaking point of substantially 25 pounds, was found to work better, as such prevents the pulling of the hairs of the mane or forelock from the animal which can be painful and cause them to spook, but also resists attempts of the animal to dismount the device 10 because it is believed to momentarily cause slight pain or irritation when pulled but not a dismount of the hair or mane to which it attaches, thereby causing the animal to cease trying to dismount it whereafter they become used to it and learn to employ it to shoo insects.

In the mode of the device 10 of FIGS. 1-2, the connector 12 can in the simplest form, be the elastic band 16 engaged with the cords 14. This is accomplished by engaging the elastic band 16 by twisting the second portion 16A around the cords 14 and engaging the first portion 17 with the mane of the animal in the simplest fashion of the device 10.

In a more preferred mode of the formed connector 12, at the first end of all of the plurality of cords 14 hanging or from a mid portion of the plurality of cords 14, at least one, and preferably a pair of elastic O-rings 18, on opposing sides of a bead 20 form the connector 12. A passage 22 (FIG. 2) running through each O-ring 18 substantially aligns with a channel 24 which runs through the bead 20 which, as noted herein, may be a liquid absorbent bead 20 in an enhanced mode of the device 10.

A diameter of each passage 22 in each elastic O-ring 18 is currently preferred to be sized smaller than the width or diameter D of the elastic band 16 (FIG. 2) running through it so as to cause a crimping or compression of the band 16 to hold it in place within each passage 22 by the outward bias of the crimped portion of the band 16 against the circumference of the passage 22. Currently, the diameter of the passages 22 are substantially ½ the width or diameter D, of the elastic band 16 and thereby each passage 22 engages in a biased compressive engagement of the passage 22 encircling a portion of the elastic band 16, once it is threaded therethrough. By substantially ½ of the diameter is meant that the diameter of the passage 22 is half the diameter of the elastic band 16 plus or minus 20%.

In the configuration of the device 10 of FIGS. 1-2, where the bead 20 and O-rings 18 are engaged to the elastic band 16 to form the more complicated mode of the connector 12, the elastic band 16, once engaged around the plurality of cords 14 at the second elastic portion 16A at an engagement end of the device 10, follows a formed pathway. This pathway runs through the passage 22 of the first O-ring 18 and continues through the channel 24 running through the bead 20 abutting the O-ring.

While a single or first O-ring will hold the second portion 16A of the band 16 stretched and cinched around the cords 14, if a second O-ring 18 is employed, the passage 22 therein abuts the channel on the opposite side of the bead 20. This forms a biased compressive engagement of both O-rings 18 in respective positions on the elastic band 16, which is preferred for stability because it thereby maintains both of the two O-rings stationary in biased engagements on portions of the elastic band 16, and holds the bead 20 in a stationary position on the elastic band 16, in-between the two O-rings on opposite sides.

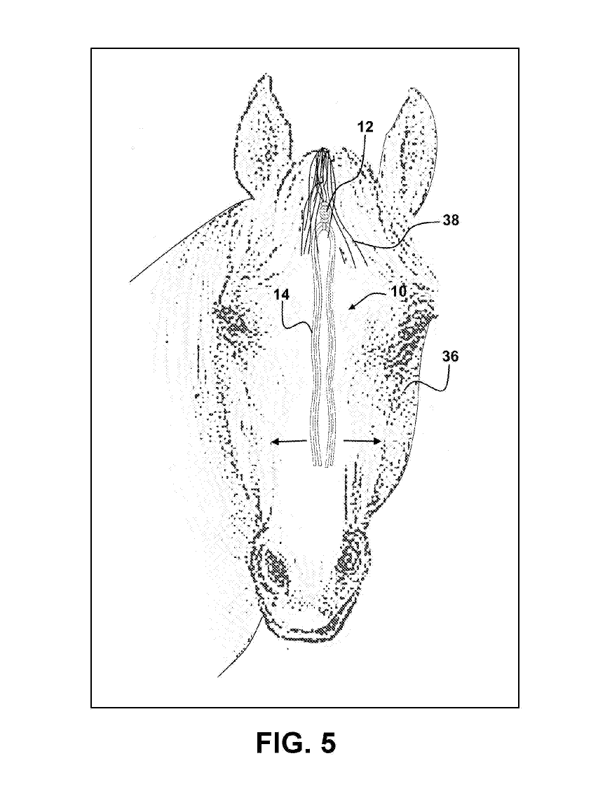

A plurality of two cords 14 forming four hanging portions of the two cords 14 from their compressive engagement at central portions thereof with the second portion 16A of the band 16 is shown in FIGS. 1-5. This plurality has been shown to work well to allow the horse to actuate the device 10 to shoo flies and insects by shaking their head, while maintaining the device 10 out of the eyesight of the animal when engaged in the as-used position shown in FIG. 5. This plurality could include more than two cords 14 such as a plurality of 3-10 cords 14 which will form double the amount of hanging portions of the cords 14 extending from their engagement with the second portion 16A of the band 16. However, it was found that maintaining the weight of the entire device 10 sufficiently lightweight so as to not be overly noticed by the animal was preferable so a plurality of between 2-6 cords worked well to that end.

A total weight of the device 10 including the connector 12 as shown in various configurations in FIGS. 1-4, and the engaged cords 14, of between 0.3 ounces and 1 ounce, has been determined as a total weight of the device 10 which when removably engaged to the forelock or mane, was not easily or overly noticed by the animal. Experimentation with multiple animals showed that most of the animals did not attempt to dismount the device 10, as occurs with bridle-engaged and heavier insect dissuading devices and vision obstructing devices, when in this weight. Consequently, a total weight of substantially between 0.3 ounces and 1 ounce is preferred for the device 10 with any mode of connector 12. By substantially between weights is meant plus or minus 25% in total weight. A slight cutting of the length of the cords 14 can allow for the connector 12 with more components as in FIGS. 1-2, but still maintain the preferred total weight.

As noted, the cords 14 as shown in FIGS. 1-5, are preferably formed of nylon or polyester in a braided configuration which renders them supple and easily bent and moved about. The cords 14 are preferably between 12-19 inches in length from their respective attachments to the connector 12 such as at the second portion 16A of the elastic band 16 to their opposite distal ends. This length, as noted, allows the cords to move to hit or dissuade flies and mosquitos and insects from the face and eyes during movement of the head of the animal, but not to hit the animal in the head during running and walking movements. The cords 14 may have a diameter between 0.5 mm and 4 mm which can be adjusted to achieve the maximum weight of the device 10 depending on the length of the cords 14 and the components included in the connector 12.

The enlarged view of the connector 12 of FIG. 1, is shown in FIG. 2, and is located, as with all modes of the device 10 of FIGS. 1-5, at a first or engagement end of the device 10. As shown, as with all modes of the device 10 herein of FIGS. 1-5, the elastic band 16 encircles cords 14 to hold them to the formed connector 12. The elastic band 16 communicates through the compressive passages 22 in a pair of O-rings 18 and through the channel 24 within the absorbent bead 20 which is in the mode of FIGS. 1-2, held in a sandwiched positioning between the two O-rings 18.

In FIG. 3 is shown the device 10 in a mode similar to FIGS. 1-2, but without the O-rings 18 as part of the connector 12. In this mode, the second portion 16A of the elastic band 16 engages around the cords 14 a portion of the elastic band 16 is in a biased compressive engagement through the channel 24 (FIG. 2) in the absorbent bead 20.

Additionally shown is a mane fastener shown as a clip 26 having adjacent openings 28 therethrough configured to form a serpentine path for engagement of the hair of the forelock or mane of the animal therethrough, much as is done with a beret, or the like, in human hair. This clip 26 can be included engaged on the elastic band 16 in a connector 12 of all modes of the device 10 herein.

Shown in FIG. 4, is the device 10 herein, in a similar configuration to that of FIGS. 1-3, but having a mane fastener which is shown as a cord lock 30 connected to one end of the elastic band 16. The cord lock 30 includes a passage 32 for compressive engagement hair of the forelock or mane therethrough, which is held therein by a spring loaded releasable piston 34. As with mane fastener provided by the clip 26, the cord lock 30 can be included at a first end or on the first portion 17 of the connector 12 of any mode of the device 10 shown herein, either with or without any of the O-rings 18 or the bead 20.

Depicted in FIG. 4A is the device 10 configured in similar but simpler fashion to that of FIGS. 1-4. In this mode of the connector 12 used with the device 10, there is no absorbent bead 20. The elastic band 16 is employed to both hold the device 10 assembled, and to hold the device 10 in operative engagement to the animal such as a horse. As shown, the elastic band 16 is held in a stretched and compressive engagement encircling the central portion of the cords 14, by compression of the elastic band 16 running through the passage 22 as shown in FIG. 2. This compressive and biased engagement on the elastic band 16 within the passage 22 which as noted has a diameter smaller that the width of the elastic band 16, holds the second elastic band portion 16A, elongated and compressively engaged around the central portion of a plurality of cords 14. At a first or connecting end of the elastic band 16, the band 16 itself can be the connector to the animal hair, or for example the a mane fasteners such as one of the clip 26 from FIG. 3, or the cord lock 30 from FIG. 4, might also be attached to provide the removable engagement to the animal.

Depicted in FIG. 5 is the device 10 in any of the modes of FIGS. 1-4, in an as-used positioning with the plurality of cords 14 hanging from the connector 12 and maintained out of the view of a horse 36. The connector 12, in any of the modes of the device 10 herein, provides for operative removable engagement with the mane, hair or as shown, the forelock 38, of the horse 36. In all modes of the device 10, the connector 12 is in a force-releasable engagement with the cords 14, such that once a predetermined maximum force is imparted to the cords 14, they will disconnect from the connector 12. Currently, the elastic band 16 is configured to break and release the cords 14 upon imparting of a force exceeding the maximum to the cords 14. As noted, a current preferred maximum force is between substantially 10-30 pounds.

Particularly preferred, in all modes of the device 10 herein shown in FIGS. 1-5, is the inclusion of a bead 20 which is fluid-absorbent such as one formed of lava, or an absorbent polymer bead or other ceramic material. The bead 20, in all modes where it is absorbent with thus absorb liquids and/or essential oils imparted thereon, and thereafter form a vapor diffuser to emit odors and or vapors from the fluid absorbed. The diffuser provided by an absorbent bead 20 so infused, will thus emit vapors and/or odors which will dissuade flies, mosquitos and the like from approaching the device 10 and the animal to which it is engaged. Currently, the provision of such an absorbent bead 20 on or adjacent the engagement end or attached to the connector 12 or around the band 16 is especially preferred, and would be infused with one or a combination of insect dissuading liquids, from a group of liquids containing lavender, peppermint, spearmint, orange, or citrus.

While all of the fundamental characteristics and features of the horse actuated force-releasable fly shooing device herein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that upon reading this disclosure and becoming aware of the disclosed novel and useful fly shooing device fro animals herein disclosed, that various substitutions, modifications, and variations may occur to and be made by those skilled in the art, without departing from the spirit or scope of the invention. Consequently, all such modifications and variations and substitutions, as would occur to those skilled in the art are considered included within the scope of the invention as defined by the following claims.

What is claimed is:

1. A fly shooing apparatus comprising:
a plurality of cords extending from an engagement with a connector;
said connector having a first end adapted for a removable engagement with the mane or forelock of an animal; and
said engagement of said plurality of cords being at a second end of said connector opposite said first end.

2. The fly shooing apparatus of claim 1, additionally comprising:
said connector having an elastic band having a diameter;
a first portion of said elastic band forming said first end of said connector, said first portion of said elastic band removably engageable in a biased compressive engagement around a portion of said mane or forelock;
a second portion of said elastic band forming said second end of said connector; and
said second portion of said elastic band in and encircling compressive of said cords.

3. The fly shooing apparatus of claim 2, additionally comprising:
said elastic band formed of an elastic material configured to break under a force of substantially 10-30 pounds.

4. The fly shooing apparatus of claim 2, additionally comprising:
a first O-ring having a passage therethrough; and
said passage having a diameter smaller than said width of said elastic band;
a section of said elastic band adjacent said second portion thereof communicating through said passage; and
said section of said elastic band forming a biased engagement with said passage of said first O-ring.

5. The fly shooing apparatus of claim 3, additionally comprising:
a first O-ring having a passage therethrough; and
said passage having a diameter smaller than said width of said elastic band;
a section of said elastic band adjacent said second portion thereof communicating through said passage; and
said section of said elastic band forming a biased engagement with said passage of said first O-ring.

6. The fly shooing apparatus of claim 2, additionally comprising:
a bead having a channel running therethrough;
said channel having a diameter smaller than said width of said elastic band;
a section of said elastic band in-between said first portion and said second portion thereof communicating through said channel; and
said section of said elastic band forming a biased engagement with said channel.

7. The fly shooing apparatus of claim 4, additionally comprising:
a bead having a channel running therethrough; and
said section of said elastic band adjacent said second portion thereof communicating through both said passage and said channel.

8. The fly shooing apparatus of claim 7, additionally comprising:
said channel having a diameter smaller than said width of said elastic band; and
said section of said elastic band forming said biased engagement with both said channel and said passage of said first O-ring.

9. The fly shooing apparatus of claim 7, additionally comprising:
said first O-ring positioned on a first side of said bead;
a second O-ring having a passage therethrough positioned on an opposite side of said bead from said first O-ring;
said passage of said second O-ring having a diameter smaller than said width of said elastic band;
said section of said elastic band adjacent said second portion thereof communicating through said passage of said first O-ring and said passage of said second O-ring and through said channel of said bead; and
said section of said elastic band forming a biased engagement with both said passage of said first O-ring and said passage of said second O-ring.

10. The fly shooing apparatus of claim 8, additionally comprising:
said first O-ring positioned on a first side of said bead;
a said second O-ring having a passage therethrough positioned on an opposite side of said bead from said first O-ring;
said passage of said second O-ring having a diameter smaller than said width of said elastic band;
said section of said elastic band adjacent said second portion thereof communicating through said passage of said first O-ring and said passage of said second O-ring and through said channel of said bead; and
said section of said elastic band forming a biased engagement with all of said passage of said first O-ring and said passage of said second O-ring and said channel of said bead.

11. The fly shooing apparatus of claim 6, additionally comprising:
said bead being absorbent of liquid; and
said bead having said liquid absorbed therein forming a diffuser for vapors from said liquid evaporating therefrom.

12. The fly shooing apparatus of claim 7, additionally comprising:
said bead being absorbent of liquid; and
said bead having said liquid absorbed therein forming a diffuser for vapors from said liquid evaporating therefrom.

13. The fly shooing apparatus of claim 8, additionally comprising:
said bead being absorbent of liquid; and
said bead having said liquid absorbed therein forming a diffuser for vapors from said liquid evaporating therefrom.

14. The fly shooing apparatus of claim 9, additionally comprising:
said bead being absorbent of liquid; and
said bead having said liquid absorbed therein forming a diffuser for vapors from said liquid evaporating therefrom.

15. The fly shooing apparatus of claim 11, additionally comprising:
said liquid being one or a combination of insect dissuading liquids, from a group of liquids containing lavender, peppermint, spearmint, orange, and citrus.

16. The fly shooing apparatus of claim 12, additionally comprising:
said liquid being one or a combination of insect dissuading liquids, from a group of liquids containing lavender, peppermint, spearmint, orange, and citrus.

17. The fly shooing apparatus of claim 5, additionally comprising:
a bead having a channel running therethrough; and
said section of said elastic band adjacent said second portion thereof communicating through both said passage and said channel.

18. The fly shooing apparatus of claim 17, additionally comprising:
said channel having a diameter smaller than said width of said elastic band; and
said section of said elastic band forming said biased engagement with both said channel and said passage of said first O-ring.

19. The fly shooing apparatus of claim 3, additionally comprising:
a releasable mane connector positioned on said first portion of said elastic band; and
said releasable mane connector being removably engageable with the hair or mane of said animal.

20. The fly shooing apparatus of claim 10, additionally comprising:
a releasable mane connector positioned on said first portion of said elastic band; and
said releasable mane connector being removably engageable with the hair or mane of said animal.
